(19) United States
(12) Patent Application Publication
(10) Pub. No.: US 2023/0230078 A1
(43) Pub. Date: Jul. 20, 2023

(54) CUSTOM TRANSACTION SCRIPTS

(71) Applicant: nChain Licensing AG, Zug (CH)

(72) Inventors: Jack Owen DAVIES, London (GB); Chloe TARTAN, London (GB); Alexander MACKAY, London (GB); Antoaneta SERGUIEVA, London (GB); Craig Steven WRIGHT, London (GB)

(21) Appl. No.: 18/009,321

(22) PCT Filed: May 12, 2021
(86) PCT No.: PCT/EP2021/062599

§ 371 Date: Dec. 8, 2022

(30) Foreign Application Priority Data
Jun. 12, 2020 (GB) 2008969.4

(51) Int. Cl. G06Q 20/38; G06Q 20/40

(52) U.S. Cl. CPC G06Q 20/389; G06Q 20/401; G06Q 20/3825

(57) ABSTRACT

A computer-implemented method of accepting blockchain transactions, wherein the method is performed by a blockchain node of a blockchain network and comprises: generating a first transaction comprising a first output, the first output comprising a first output script; causing the first transaction to be published on the blockchain; receiving a second transaction comprising a second output, the second output comprising a second output script; and accepting the second transaction based on one or more conditions being met, wherein a first condition of said one or more conditions is that the second output script corresponds to the first output script.

### CROSS REFERENCE TO RELATED APPLICATIONS

This application is the U.S. National Stage of International Application No. PCT/WP2021/062599 filed on May 12, 2021, which claims the benefit of United Kingdom Patent Application No. 2008969.4, filed on Jun. 12, 2020, the contents of which are incorporated herein by reference in their entireties.

### TECHNICAL FIELD

The present disclosure relates to a method of choosing whether to accept a blockchain transaction, e.g. whether a blockchain node chooses to publish a transaction in a block or to propagate to other blockchain nodes.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

### SUMMARY

In addition to consensus rules, a blockchain node may apply one or more local policy rules that allow that node to further refine the transactions they are willing to publish in a block.

Some blockchain networks are more restrictive than others with regards to the types of input scripts and/or output scripts that are allowed to be included in a valid transaction. That is, some networks are more flexible in others in the transaction scripts that parties (e.g. users) can use to lock an output of a transaction, e.g. to allow more complex locking scripts. However, there is currently no method for a blockchain node to communicate the types of scripts that can be included in a transaction that the node is willing to accept (e.g. publish in a block constructed by that node), or that the node will priorities for acceptance.

There is therefore a need for a node to be able to communicate that the node will process and accept a particular script type, and equally for a user to be able to obtain scripts (e.g. “template” scripts) that will be accepted by the node.

According to one aspect disclosed herein, there is provided a computer-implemented method of accepting blockchain transactions, wherein the method is performed by a blockchain node of a blockchain network and comprises: generating a first transaction comprising a first output, the first output comprising a first output script; causing the first transaction to be published on the blockchain; receiving a second transaction comprising a second output, the second output comprising a second output script; and accepting the second transaction based on one or more conditions being met, wherein a first condition of said one or more conditions is that the second output script corresponds to the first output script.

The blockchain node registers the transaction template (i.e. the first transaction) on the blockchain. The party (e.g. a user) is therefore able to obtain the transaction template and use it to generate their own transaction which has a script corresponding to the “template” script. For instance, the script in the user's transaction may follow the same format as the template script with variables (e.g. a public key) chosen by the user in place of any variables, or null data, chosen by the blockchain node. When the blockchain node receives the user's transaction, the blockchain node checks whether it corresponds to the template transaction, and if so, accepts the user's transaction. The blockchain node may then attempt to publish the user's transaction in a block constructed by the node, and/or propagate the transaction to other nodes.

According to one aspect disclosed herein, there is provided a computer-implemented of generating blockchain transactions, wherein the blockchain comprises a first transaction comprising a first output that comprises a first output script, and a third transaction comprising a first input that comprises a first input script, wherein the first input script is configured, so as when executed alongside the first output script, to unlock the first output script, and wherein the first and third transactions are generated by a blockchain node; the method being performed by a party and comprising: obtaining the first transaction and/or the third transaction; generating a second transaction comprising a) a second output comprising a second output script corresponding to the first script of the first transaction, and/or b) a second input comprising a second input script corresponding to the first input script of the first template transaction; and causing the second transaction to be transmitted to the blockchain node.

The template transactions have been published on the blockchain and the user wishes to use the template scripts to generate their own transaction. The user obtains the template transaction(s), e.g. by requesting them from the blockchain. Once the user knows the template script that will be accepted by the blockchain node, the user can generate their own transaction using a corresponding script and transmit their transaction to the blockchain node.

In summary, the present invention enables blockchain nodes to register transaction templates on the blockchain, thus signalling their local policy rules. Blockchain nodes can use the method to publicise their list of whitelisted transactions types, giving users information helping them to connect to suitable nodes when they need to use custom scripts.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 is a schematic block diagram of some node software for processing transactions,

FIG. 4 is a schematic block diagram of a system for implementing embodiments of the present invention,

FIG. 5 is a schematic representation of an example first template transaction,

FIG. 6 is a schematic representation of an example second template transaction,

FIG. 7 is an expanded view of the second template transaction of FIG. 6,

FIG. 8 illustrates example data fields that may be included in the example template transactions of FIGS. 5 to 7,

FIG. 9 illustrates example byte codes that can be used to signal the type of data to include in a candidate script,

FIG. 10 is a schematic representation of an example consolidation transaction,

FIG. 11 illustrates example data fields that may be included in the example consolidation transaction of FIGS. 10,

FIGS. 12a and 12b are schematic representations of example first and second template transactions,

FIG. 12c is an expanded view of the template transactions of FIGS. 12a and 12b,

FIGS. 13a and 13b are schematic representations of further example first and second template transactions, and

FIG. 13c is an expanded view of the template transactions of FIGS. 13a and 13b.

### DETAILED DESCRIPTION OF EMBODIMENTS

Example System Overview

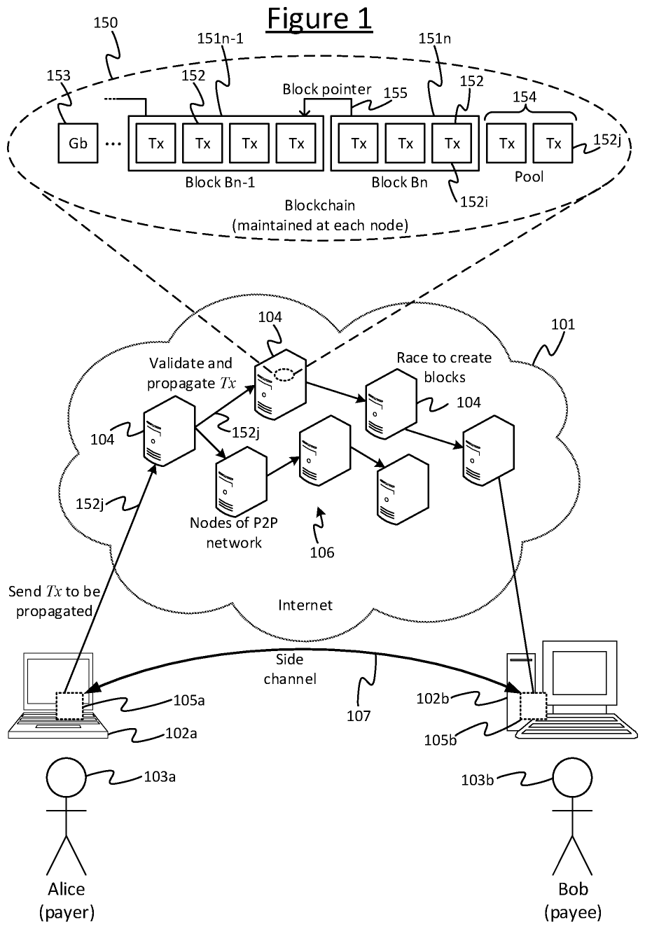

FIG. 1 shows an example system 100 for implementing a blockchain 150. The system 100 may comprise of a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n−1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

UTXO-Based Model

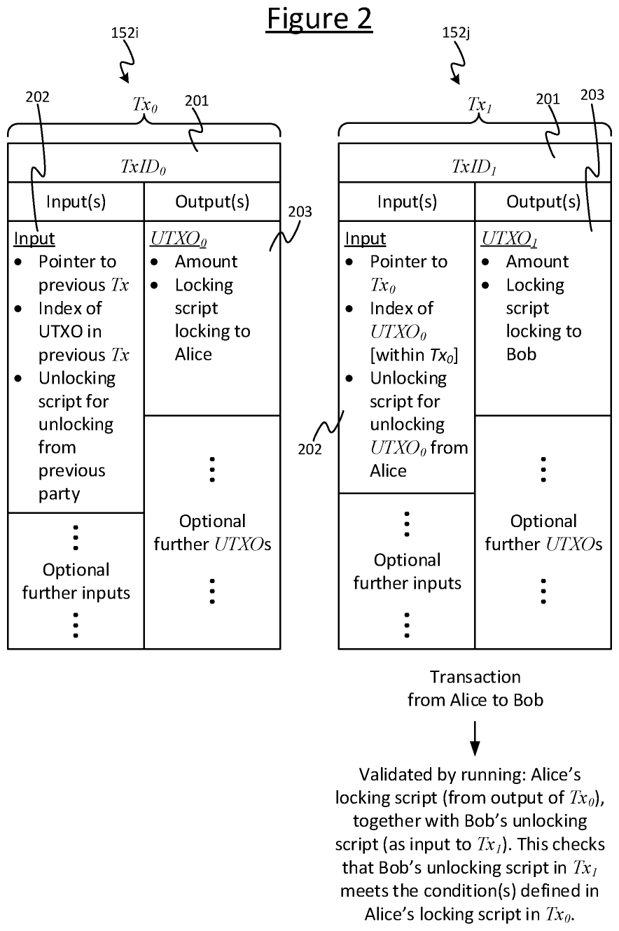

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}><P_{A}>∥[Checksig P_{A}]

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

Node Software

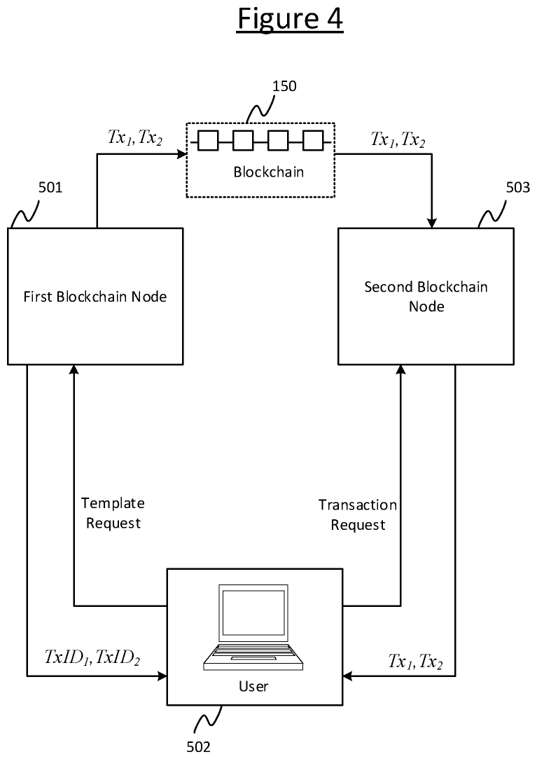

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

Transaction Templates

As mentioned above, each blockchain node 104 of the blockchain network 106 applies the same consensus rules when validating transactions. Transactions 152 that violate the consensus rules will be rejected and not published on the blockchain nor propagated to other nodes 104. A node 104 may also choose to apply their own configurable policy rules Policy rules are additional rules that an individual node 104 can set to further restrict the number of possible transactions 151 it will accept for publication in a block and for propagating to other nodes 104. Accepting a transaction 151 for publication may comprise placing a transaction in one of several different “transaction queues”, each queue being processed at a different speed. In other words, some transaction types may be processed faster than others, meaning that some transaction types may be included in a new block 152 before others. As a particular example, a transaction having a pay-to-public-key-hash (P2PKH) script format may be placed in a “fast queue” to be processed ahead of other, perhaps more complex, scripts. In some examples, a node 104 may perform a combination of prohibiting some transaction types and placing other particular transaction types in different transaction queues.

A node 104 can choose not to propagate an unpublished (i.e. pending) transaction 152j that violates its own policy rules. Similarly, a node 104 may choose to apply certain local policy rules when validating a new block 151n that has been produced by a different node 104. For instance, a node 104 may operate a local policy that rejects a block 151n that is too large, i.e. above a maximum block size. This does not mean that the block itself 151n will be rejected by the network 106, rather it means that the particular node 104 does not take part in validating the block 151n.

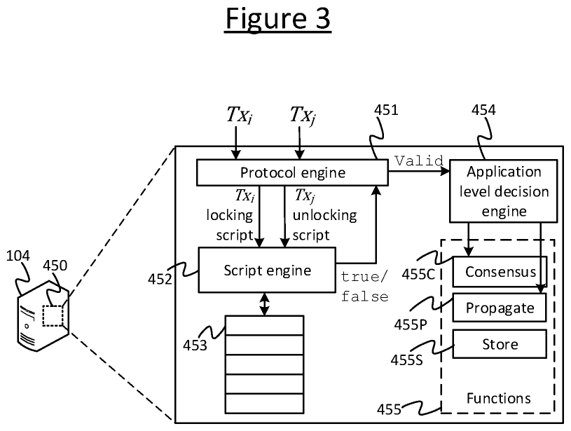

Typically the local policy rules for accepting a new block 151 will be weaker than the local policy for producing a new block 151. Therefore a node 104 may still accept (i.e. validate) a block 151 containing transactions that do not comply with its own policy rules for producing blocks. These policy rules may be implemented as the level rules applied by the application-level decision engine of FIG. 3.

Some blockchain networks 106, e.g. the Bitcoin network, supports a range of complex transaction locking conditions, i.e. locking scripts that lock an output of a transaction. In general, a node 104 may set node-configurable limits which means that the node can decide which transactions they will include in a newly constructed block as a matter of policy, but must process transactions if they are contained in blocks distributed by other nodes 104.

A configurable rule set means that some nodes 104 will accept a particular transaction for publishing in a block, while other nodes may choose not to include that transaction in a newly constructed block. The table below shows the example limits which are configurable by any given node 104. Note that the current value may for any given limit (e.g. transaction size) may change over time.

| Relevant limit | Parameter | Current value | |
|---|---|---|---|
| Block size | MAX_BLOCK_SIZE | 2 | GB |
| Transaction size | MAX_STANDARD_TX_SIZE | 1 | MB |
| Transaction element count | MAX_OPS_PER_SCRIPT | 500 | |
| Maximum script size | MAX_SCRIPT_SIZE | 1000 | bytes |
| Maximum stack size | MAX_STACK_MEMORY_USAGE | 100 | MB |
| Maximum number of Checksig | MAX_TX_SIGOPS_COUNT | 20,000 | |
| operations per script | | | |
| Maximum number of Checksig | MAX_BLOCK_SIGOPS_PER_MB | 20,000 | |
| operations per MB | | | |
| Script element size | MAX_SCRIPT_ELEMENT_SIZE | 520 | bytes |

| | | |
|---|---|---|
| Maximum number of public | MAX_PUBKEYS_PER_MULTISIG | 20 |
| keys per Multisig operation | | |

FIG. 4 illustrates an example system for registering transaction templates on the blockchain 150. The system comprises a first blockchain node 501 and a user 502. It will be appreciated that reference to “a user” may be used as a short-hand to mean the computer equipment operated by the user 502. The user may perform one, some or all of the actions associated with Alice 103a or Bob 103b with reference to FIGS. 1 and 2. In some embodiments, the system further comprises one or more additional blockchain nodes 503.

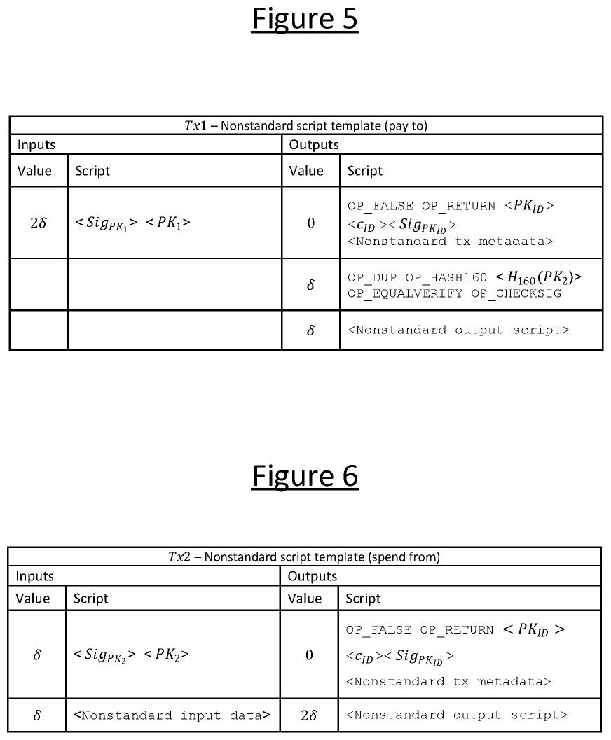

The first blockchain node 501 generates a first template transaction. The first template transaction contains a first output that includes a template output script that the first blockchain is willing to accept. An example of a first template transaction is shown in FIG. 5. The template output script is denoted by “<Nonstandard output script>”. The first template transaction includes an input that spends an output of a previous transaction (previous in the sense that it has been previously submitted to the blockchain network 106 for publishing in a block). The input may include a public key associated with the first blockchain 501. The input may also include a signature that signs some or all of the first template transaction.

In some examples, the first template transaction may comprise one or more further inputs and/or one or more further outputs. For instance, the first template transaction may comprise a second output that is locked to a public key of the first blockchain node 501. For example, the second output may be a P2PKH output locked to an address based on the public key of the first blockchain node 501, as shown in FIG. 5. In some examples, the address may be a hash of the public key. The public key included in the input and the public key to which the second output is locked may be the same public keys or different public keys (which may or may not be mathematically linked to one another).

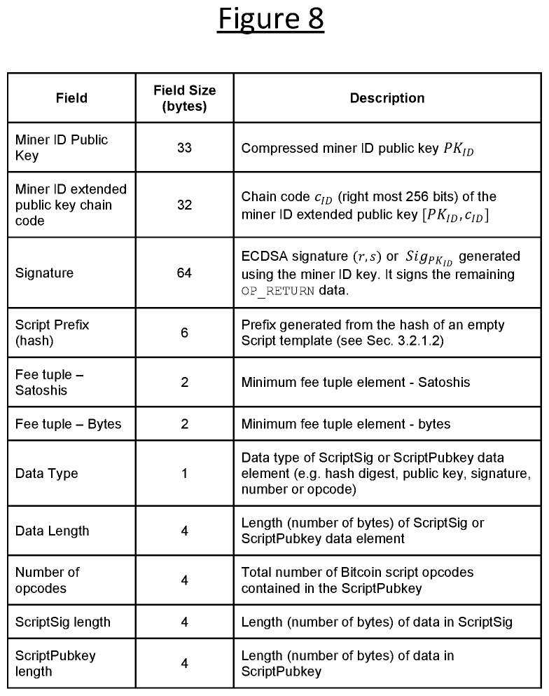

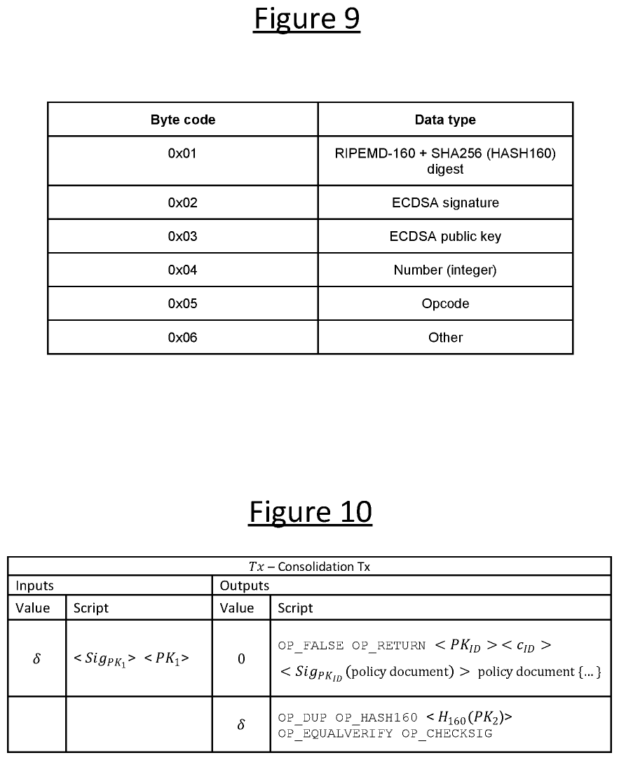

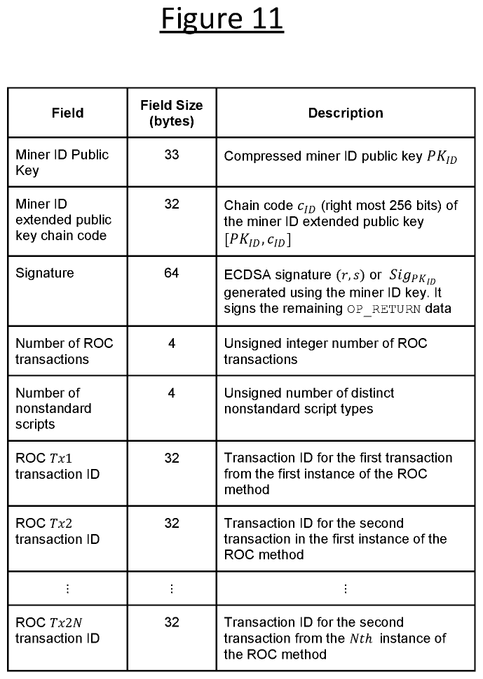

The first template transaction may also comprise a third output that contains data relating to the template output script. The third output may be an unspendable output, e.g. an “OP_RETURN output”. Note that OP_RETURN may be used herein as shorthand for OP_FALSE OP_RETURN or OP_0 OP_RETURN. Alternatively, the data may be included in a spendable output. The third output may comprise one or more of the data fields shown in FIGS. 7 and 8. For instance, the third output may comprise a master public key associated with the first blockchain node 106. The master public key, sometimes referred to as a “Miner ID” public key, may be mathematically linked to the respective public keys included in the input and/or second output of the first template transaction. The third output may include a chain code for deriving the master public key, which may be used to link the master public key with the above-mentioned public key(s). The third output may comprise a signature that signs some or all of the third output, e.g. a signature generated using the private key corresponding to the master public key. One or more further data fields may be included in the third output, e.g. a data length (number of bytes) of the template output script, a data length (number of bytes) of the template input script, and/or a total number of opcodes contained in the template output script.

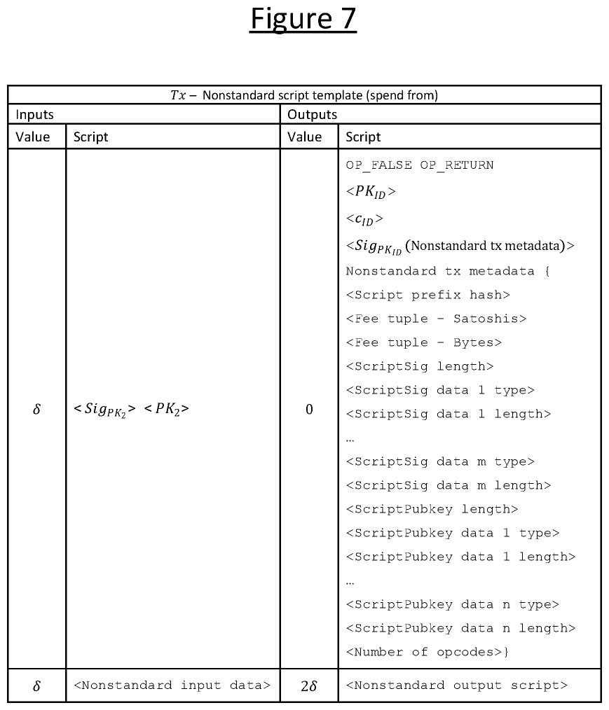

The first blockchain node 501 may also generate a second template transaction. The second template transaction contains a first input that includes a template input script that the first blockchain node is willing to accept for publishing in a new block. The template input is also configured to unlock the template output script included in the first template transaction. That is, if the template output script was executed alongside the template input script, the execution would validly complete. An example of a second template transaction is shown in FIG. 6. The template output script is denoted by “<Nonstandard input data>”.

In some examples, the first input of the second template transaction references the first output of the first template transaction. That is, the first input of the second template transaction is configured to unlock the first output of the first template transaction. The second template transaction may include one or more further inputs and/or or one or more further outputs. For instance, the second template transaction includes a second input that spends an output of a previous transaction. The second input may include a public key associated with the first blockchain node 501. The second input may also include a signature that signs some or all of the first template transaction. For example, the second input of the second template transaction may reference, and be configured to unlock, the second output of the first template transaction, e.g. the P2PKH output of the first template transaction. The second template transaction may comprise a first output that includes some or all of the data fields included in the third output of the first template transaction. That is, the first output of the second template transaction may be an unspendable output. The second template transaction may, additionally or alternatively, include a second output that comprises the template output script of the first template transaction.

The first blockchain node 501 causes the first and second transactions to be submitted to the blockchain 150. The first blockchain node 501 may publish the first and second template transactions in the same block 151, or in different blocks. Alternatively, the first blockchain node 501 may forward the first and second template transactions to a different node 104 which then publishes the transactions in a new block or blocks 151.

Once published on the blockchain 150, a user 502 may use the template transaction(s) to generate their own transaction(s). A transaction generated by the user 502 will be referred to as a “candidate transaction”, but it will be understood that this is merely a label.

The user 502 obtains at least the first template transaction. The user 502 may also obtain the second template transaction. The first template transaction enables the user 502 to submit a first candidate transaction to the first blockchain node 501 that includes an output script corresponding to the template output script. The second template transaction enables the user 502, or another user, to generate a second candidate transaction that includes an input script configured to unlock the first candidate transaction.

There are various ways in which the user 502 may obtain the template transaction(s). As a first option, the user 502 may scan the blockchain for the template transaction(s), e.g. the template transaction(s) may include an identifier of the first blockchain node 501 and/or a flag that identifies the template transaction(s) as containing template scripts. As another option, the user 502 may obtain respective transaction identifiers of the template transactions, and use those transaction identifiers to obtain the template transactions from the blockchain 150. For instance, the user 502 may transmit a request to the first blockchain node 501 for the template transactions, and the first blockchain node 501 may return the transaction identifiers. In some examples, the first blockchain node 501 may return the full transaction template(s), or at least the template scripts. As another option, the user 502 may obtain the transaction identifier(s) from the first blockchain node 501, and transmit a request for the transaction templates to a different node 503. That other node 503 may then return the transaction template(s) to the user 502.

To verify that the template transaction(s) have indeed been published on the blockchain 150, the user 502 may request a Merkle proof of existence of the first and/or second template(s). The user 502 may submit the request to the first blockchain node 501 or another node 503.

Once obtained, the user 502 may verify that the first and/or second template transactions comprise a respective public key associated with the first blockchain node 501. For instance, the user 502 may verify that the first and/or second template transactions comprise the master public key (Miner ID) of the first blockchain node 501. In some examples, the user 502 may verify that the first and/or second template transactions comprise a respective public key linked to the master public key.

The user 502 generate a candidate transaction and causes it to be transmitted to the first blockchain node 501. The user 502 may transmit the candidate transaction directly to the first blockchain node 501, or the user 502 may transmit the candidate transaction to another party for forwarding to the first blockchain node 501. The candidate transaction comprises an output script corresponding to the template output script, and/or an input script corresponding to the template input script.

The first blockchain node 501 receives at least a first candidate transaction that comprises a candidate output script. The first blockchain node 501 may receive the first candidate transaction directly from the user 502, or via one or more other nodes 104. The first blockchain node 501 determines whether the candidate output script corresponds to the template output script. If the candidate output script does correspond to the template output script, the first blockchain node accepts the first candidate transaction (assuming that all other conditions have been met, e.g. the consensus rules of the network 106).

In order for the first blockchain node 501 to accept the first candidate transaction, the first blockchain node may check whether one, some or all of the following conditions have been met: the candidate output script comprises a same number of operation codes (opcodes) as the template output script, the candidate output script comprises a same order of operation codes (opcodes) as the template output script, the candidate output script comprises a same number of data items (e.g. non-opcodes) as the template output script, the candidate output script comprises a same order of data items as the template output script, and/or the candidate output script comprises a same format of data items as the template output script.

If the first blockchain node 501 accepts the first candidate transaction, the first blockchain node 501 will attempt to include the first candidate transaction in a newly constructed block 151 of the blockchain 150 and/or propagate the first candidate transaction to other nodes 104 of the network 106.

In some embodiments, the first blockchain node 501 may receive a second candidate transaction comprising a candidate input script, e.g. one that spends the candidate output of the first candidate transaction. The first blockchain node 501 may perform the same checks on the candidate input script, i.e. determining if the number, order and/or type of opcodes and/or data items included in the candidate input script correspond, respectively, to the number, order and/or type of opcodes and/or data items included in the template input script.

In addition to generating the first and second template transactions, the first blockchain node 501 may generate one or more further pairs of template transactions. Each pair of template transactions may include a different template output script and template input script. The first blockchain node 501 may cause each pair of template transactions to be published on the blockchain 150.

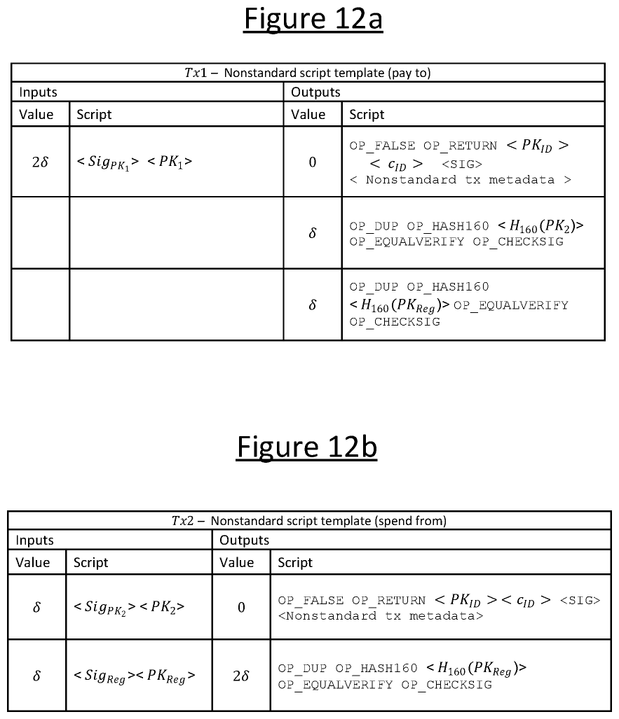

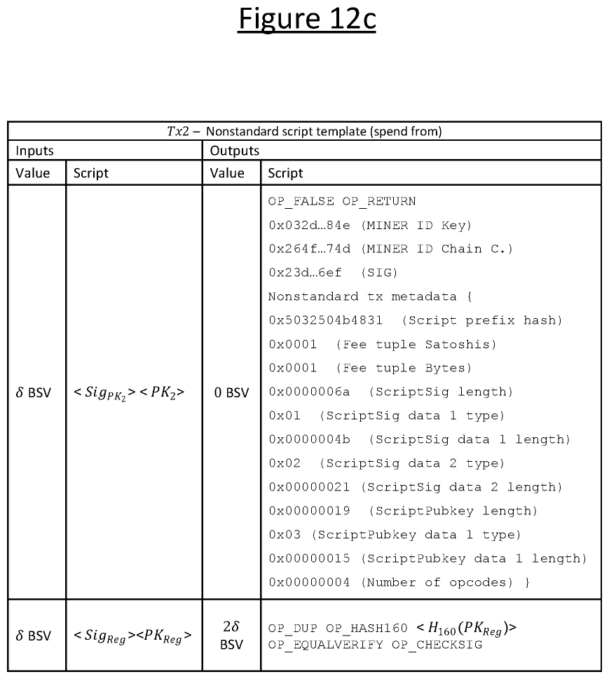

The first blockchain node 501 may generate a consolidation transaction. An example consolidation transaction is shown in FIG. 10. The consolidation comprises a first output (e.g. an unspendable output) that includes the respective transaction identifiers of the first and second template transactions. In some examples, the first output also includes the respective identifiers of each further pair of template transactions. In response to a request from a user 502, the first blockchain node 501 may return the transaction identifier of the consolidation transaction, thus providing another way for the user 502 to obtain the desired template transaction(s). FIG. 11 illustrates an example set of data fields that may be included in the first output of the consolidation transaction.

### SPECIFIC EXAMPLE

Setup: A node 104 holds a Miner ID ECDSA key pair sk_{ID}, PK_{ID} (where PK_{ID}=sk_{ID}. G).

Step 1: The node 104 creates a custom transaction (Tx1) containing a nonstandard output script and a transaction (Tx2) containing a corresponding nonstandard input script that spends the nonstandard output in Tx1.

Step 1b: The node 104 constructs a new block containing both Tx1 and Tx2. This block is broadcast to the rest of the network 106.

Step 2: A user makes a request for the custom nonstandard transaction created by the node 104.

Step 3: The node 104 sends back the TXIDs for Tx1 and Tx2.

Step 4: The user requests full transaction data from a different node 104 (see alternative).

Step 4 (alternative): The user can request a Merkle proof of inclusion for Tx1 and Tx2 as well as block header information.

Step 5: The other node sends back Tx1 and Tx2, which should have been published in a valid block.

Step 6: The user validates the Miner ID authentication signature and extracts custom script data.

Step 7: The user verifies that PK₁, PK₂ are linked to PK_{ID}, e.g. using a child key derivation function.

The method allows the user (i.e. the user's client application) to extract the following four data items from the blockchain:
Miner ID public key: PK_{ID}
Tx type: <custom Tx name>
ScriptSig (input): <Nonstandard input data>
ScriptPubkey (output): <Nonstandard output script>

Once the user 502 has obtained this information, the user 502 can be confident that the node 104 that created both transactions will publish and propagate transactions containing the specified nonstandard scripts.

The method may use two chained transactions: Tx1 and Tx2 (see FIGS. 5 and 6). They contain P2PKH, OP_RETURN data and nonstandard script outputs. Both Tx1 and Tx2 may be required to ensure that the nonstandard output created by the node 104 is acceptable according to the network consensus rules. In some examples, both of the spendable outputs of Tx1 must be spent by Tx2. This acts as a safety measure for users by preventing the loss of funds that could result from scripting errors. Both transactions may contain regular P2PKH inputs containing signatures with a SIGHASH_ALL signature hash type in order to prevent transaction input malleability being exploited by an attacker.

Furthermore, as these transactions are created by the node 104, there is no requirement for the transactions to include a transaction fee. In fact, a node 104 may deliberately choose not to include a transaction fee so that the transaction is unlikely to be published in a block constructed by a different node 104, even if it has been seen by other nodes 104 on the network 106.

The provably unspendable output in the template transactions contain metadata containing information about the nonstandard input data and corresponding nonstandard script outputs as well as useful CPU cost metrics. The table in FIG. 8 lists the null data OP_RETURN fields.

Miner ID and signature: The null data payload begins with the compressed miner ID public key followed by an ECDSA signature generated using the Miner ID private key and message comprising the script mapping data following the signature (i.e. the contents of the OP_RETURN payload minus the Miner ID key and signature itself).

Script prefix/Script identifier: The script prefix is a unique identifier for the script type. Taking the first 6 bytes of the SHA256 hash of the ScriptPubkey minus any user specific data:
H(empty template) [0: 6]

An empty template represents the script minus user specific template data. For example, consider the following prefix generation for a P2PKH transaction.

P2PKH ScriptPubkey: 76a91412d9253a252ca9bbbcdefd0b077e83666d12f12388ac

P2PKH empty template: 76a914000000000000000000000000000000000000000088ac H(empty template) [0:6]=9a5d6f105da6

Fee tuple: Fee tuple is a data structure used to signal the minimum transaction fee charged by the node 104 for publishing the transaction in a newly constructed block. For example, 1 Satoshi per byte is equivalent to a fee tuple of [0x0001 0x0001] while 3 Satoshis for every 5 bytes is represented by a fee tuple of [0x0003 0x0005].

Data type and length: The ‘data type’ and ‘data space’ are used to indicate the lengths and types of data used to create the ScriptSig (input) and ScriptPubkey (output), thus giving the user a more detailed description of how to construct the transaction.

Each output script will contain data specific to the user and transaction, but transaction types follow a similar pattern. For example, in a pay-to-public-key hash the output contains a 20-byte hash digest and 4 opcodes. The corresponding input will contain a 75-byte signature and a 33-byte or 65-byte public key.

Number of opcodes: The number of opcodes in the ScriptPubkey is a useful metric for determining how expensive the script execution will be. The script lengths of the inputs and outputs are another useful metric for determining how expensive the script execution will be.

Once a node 104 has performed the above method multiple times and has published a set of nonstandard transactions, they may need to keep track of a list of TxIDs, transmitting them to entities that request the template scripting information. To minimize the list size the node 104 can create a consolidation transaction containing a Policy Document. The policy document itself is a list of all transaction IDs for template transactions they have mined.

By collecting the list of relevant template transaction IDs and publishing them on chain, the burden of maintaining a growing list of TxIDs is eliminated, instead reducing it to a single TxID. The data required to find the relevant scripts now being on chain itself. By obtaining a single policy list TxID the data can be fetched from multiple nodes 104, diffusing the workload amongst all nodes on the network. FIG. 10 illustrates the contents of a consolidation transaction.

In a similar fashion, the node 104 can create minimal value OP_RETURN/data transactions encoding the template data and publish those transactions in a block 151, thus making the data readily available across the network 106. FIG. 11 provides a description of the OP_RETURN fields of the consolidation transaction.

In practice, the keys sk₁, sk₂ (corresponding to PK₁ and PK₂ respectively) that are used to sign for the template transactions should be different from the Miner ID key sk_{ID}, which is used to generate the signature Sig_{PK}_{_{ID}}(Policy document) in the OP_RETURN data field. However, this introduces the risk that the OP_RETURN data can be copied and put into another transaction not created by the entity controlling the Miner ID keys, thereby not guaranteeing that the nonstandard scripts will be accepted. This can be remedied by using child key derivation to link the keys. For example, according to the BIP32 protocol (https://github.com/bitcoin/bips/blob/nnaster/bip-0032.mediawiki), the child key derivation functions CKDpriv and CKDpub can be used directly as follows to generate private keys:

$$[ s {k}_{1} , {c}_{1} ] = CKDpriv [ {sk}_{ID} , {c}_{ID} ] , 1 ) , \\ [ {sk}_{2} , {c}_{2} ] = CKDpriv [ {sk}_{ID} , {c}_{ID} ] , 2 ) , \\ ⋮ \\ [ {sk}_{N} , {c}_{N} ] = CKDpriv [ {sk}_{ID} , {c}_{ID} ] , N ) , \\ and corresponding public keys : \\ [ {PK}_{1} , {c}_{1} ] = CKDpub ( [ P {K}_{ID} , {c}_{ID} ] , 1 ) , [ P {K}_{2} , {c}_{2} ] = CKDpub ( [ P {K}_{ID} , {c}_{ID} ] , 2 ) , \\ ⋮ \\ [ {PK}_{N} , {c}_{N} ] = CKDpub ( [ P {K}_{ID} , {c}_{ID} ] , N ) ,$$

where c_{ID} is the chain code (right most 256 bits) of the extended public key, and the index range (1, . . . , N) can be added as a field to the OP_RETURN output of the template transactions. Any recipient of the template transactions can use the CKDpub functions to verify the link between the two keys. This method ensures that the transaction being viewed by the recipient has in fact been created by an entity in control of the miner ID keys.

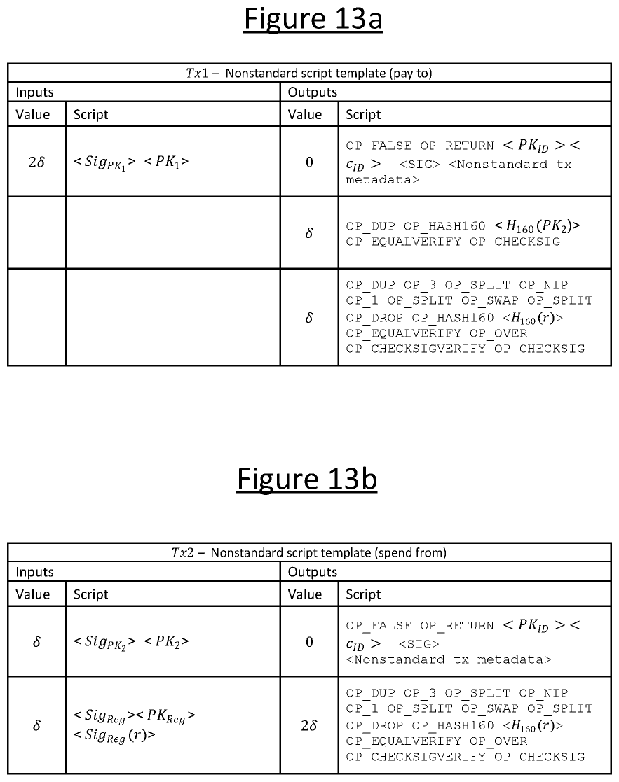

FIGS. 12a and 12b illustrate example first and second template transactions comprising, respectively, a template output script for implementing a pay-to-public-key-hash (P2PKH) output, and a template input script for spending the P2PKH output. P2PKH is a regular transaction that pays to the HASH160 of an ECDSA public key. The recipient can unlock the output by providing a signature matching the public key used to create the public key hash. FIG. 12c illustrates the OP_RETURN data of the template transactions of FIGS. 12a and 12b.

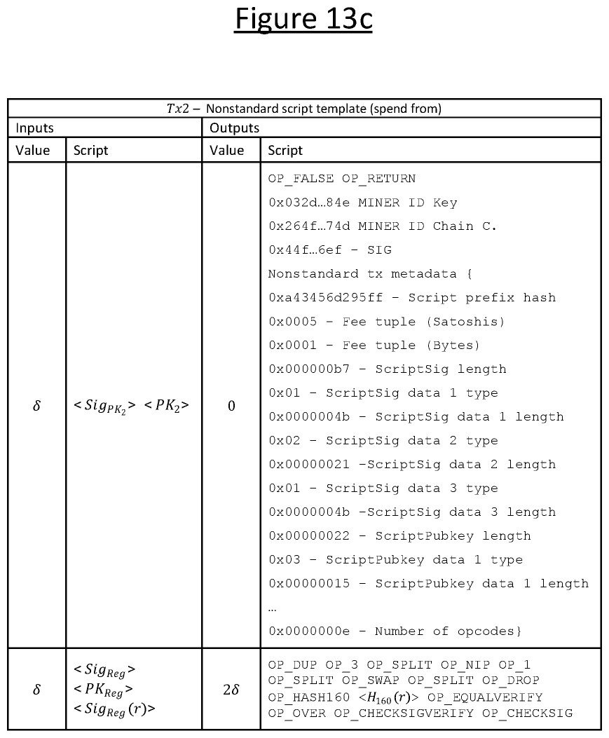

FIGS. 13a and 13b illustrate example first and second template transactions comprising, respectively, a template output script for implementing a pay-to-R-puzzle-hash (P2RPH) output, and a template input script for spending the P2RPH output. P2PPH is a nonstandard transaction that pays to a script that checks whether the spender uses a particular public ephemeral key to generate the r component of the transaction ECDSA signature. Two signature checks are required to secure P2RPH transactions, making the execution more expensive than a regular transaction. FIG. 13c illustrates the OP_RETURN data of the template transactions of FIGS. 13a and 13b.

Conclusion

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In non-preferred embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1. A computer-implemented method of accepting blockchain transactions, wherein the method is performed by a blockchain node of a blockchain network and comprises:
generating a first transaction comprising a first output, the first output comprising a first output script;
causing the first transaction to be published on the blockchain;
receiving a second transaction comprising a second output, the second output comprising a second output script; and
accepting the second transaction based on one or more conditions being met, wherein a first condition of said one or more conditions is that the second output script corresponds to the first output script.

Statement 2. The method of statement 1, comprising:
generating a third transaction comprising a first input, the first input comprising a first input script, wherein the first input script is configured, so as when executed alongside the first output script, to unlock the first output script; and
causing the third transaction to be published on the blockchain.

Statement 3. The method of statement 2, comprising:
receiving a fourth transaction comprising a fourth input, the fourth input comprising a second input script; and
accepting the fourth transaction based on one or more conditions being met, wherein a first condition of said one or more conditions is that the second input script corresponds to the first input script.

Statement 4. The method of any preceding statement, wherein accepting the second transaction comprises causing the second transaction to be published on the blockchain.

Statement 5. The method of statement 4, wherein said causing of the second transaction to be published on the blockchain comprises publishing the second transaction on the blockchain and/or propagating the second transaction to one or more blockchain nodes.

Statement 6. The method of any preceding statement, wherein said causing of the first transaction to be published on the blockchain comprises publishing the first transaction on the blockchain and/or propagating the first transaction to one or more different blockchain nodes.

Statement 7. The method of any preceding statement, wherein said receiving of the second transaction comprises receiving the second transaction from a party that generated the second transaction.

Statement 8. The method of any of statement 1 to 6, wherein said receiving of the second transaction comprises receiving the second transaction from a different blockchain node. or from a relaying node of the blockchain network.

Statement 9. The method of any preceding statement, wherein the first and third transactions are each identified by a respective transaction identifier, and wherein the method comprises:
receiving, from a party, a request for the respective identifiers of the first and third transactions; and
transmitting the respective identifiers of the first and third transactions to the party.

Statement 10. The method of any preceding statement, wherein in order for the second output script to correspond to the first output script, one, some or all of the following conditions must be met:
the second output script comprises a same number of operation codes as the first output script,
the second output script comprises a same order of operation codes as the first output script,
the second output script comprises a same number of data items as the first output script,
the second output script comprises a same order of data items as the first output script, and/or
the second output script comprises a same format of data items as the first output script.

Statement 11. The method of any preceding statement, wherein the first input of the third transaction references the first output of the first transaction.

Statement 12. The method of any preceding statement, wherein the first transaction comprises a third output locked to a first public key of the blockchain node.

For instance, the third output may be a P2PKH hash output locked to a hash of the first public key.

Statement 13. The method of statement 12, wherein the third transaction comprises a second input, and wherein the second input is configured, so as when executed alongside the third output of the first transaction, to unlock the third output of the first transaction.

Statement 14. The method of statement 13, wherein the second input of the third transaction comprises a signature generated by the blockchain node, the signature signing some or all of the inputs and/or outputs of the third transaction.

Statement 15. The method of any preceding statement, wherein the first and/or third transaction comprises an identifier of the blockchain node.

For instance, the identifier may be a public key associated with the blockchain node, or other identifying information, e.g. name, IP address, etc.

Statement 16. The method of statement 15, wherein the identifier of the blockchain node comprises the first public key or a second public key of the blockchain node.

Statement 17. The method of statement 2 or any statement dependent thereon, wherein the third transaction comprises a fourth output, the fourth output comprising the first output script.

Statement 18. The method of any preceding statement, wherein the first and/or third transaction comprise a respective output comprising one, some or all of:
a master public key associated with the blockchain node;
a chain code linking the master public key with the first public key and/or the second public key;
a signature generated using the master public key;
a data length of the template output script;
a data length of the template input script;
a total number of opcodes contained in the template output script.

Statement 19. The method of any preceding statement, comprising:
generating a fifth transaction comprising a fifth output, the fifth output comprising a respective transaction identifier of the first and third transactions.

Statement 20. The method of statement 19, wherein the fifth output of the fifth transaction comprises one or more pairs of respective transaction identifiers, each pair comprising a respective transaction identifier of a different first transaction and a respective transaction identifier of a different third transaction, each different first and third transaction comprising, respectively, a different first output script and a different first input script.

Statement 21. A computer-implemented of generating blockchain transactions, wherein the blockchain comprises a first transaction comprising a first output that comprises a first output script, and a third transaction comprising a first input that comprises a first input script, wherein the first input script is configured, so as when executed alongside the first output script, to unlock the first output script, and wherein the first and third transactions are generated by a blockchain node; the method being performed by a party and comprising:
obtaining the first transaction and/or the third transaction;
generating a second transaction comprising a) a second output comprising a second output script corresponding to the first output script of the first transaction, and/or b) a second input comprising a second input script corresponding to the first input script of the third transaction; and
causing the second transaction to be transmitted to the blockchain node.

Statement 22. The method of statement 21, wherein said obtaining of the first and/or third transactions comprises obtaining the first and/or third transactions from the blockchain.

Statement 23. The method of statement 21 or statement 22, wherein the first and third transactions are each identified by a respective transaction identifier, and wherein said obtaining comprises obtaining the respective transaction identifiers of the first and/or third transactions.

Statement 24. The method of statement 23, wherein said obtaining comprises transmitting a request to the blockchain node for the first and/or third transactions.

Statement 25. The method of statement 21 or statement 22, comprising:
transmitting a request for the first and/or third transactions to a different blockchain node, wherein the request comprises the respective transaction identifiers of the first and/or third transactions, and wherein said obtaining comprises obtaining the first and/or third transactions from the different node.

Statement 26. The method of any of statements 21 to 25, comprising:
transmitting, to the blockchain node, a request for a respective Merkle proof of the first and/or third transactions being published on the blockchain.

Statement 27. The method of any of statements 21 to 26, wherein the first and/or third transactions each comprise a master public key, and wherein the method comprises verifying that the master public key is associated with the blockchain node.

Statement 28. The method of statement 27, wherein the first transaction comprises a first public key and/or the third transaction comprises a second public key, and wherein the method comprises verifying that the first and/or second public keys are linked to the master public key.

Statement 29. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 28.

Statement 30. A computer program embodied on computer-readable storage and configured so as, when run on computer equipment, to perform the method of any of statements 1 to 28.

According to another aspect disclosed herein, there may be provided a method comprising the actions of the blockchain node and the party.

According to another aspect disclosed herein, there may be provided a system comprising the computer equipment of the blockchain node and the party.

1. A computer-implemented method of accepting blockchain transactions, wherein the method is performed by a blockchain node of a blockchain network and comprises:
generating a first transaction comprising a first output, the first output comprising a first output script;
causing the first transaction to be published on the blockchain;
receiving a second transaction comprising a second output, the second output comprising a second output script; and
accepting the second transaction based on one or more conditions being met, wherein a first condition of said one or more conditions is that the second output script corresponds to the first output script.

2. The method of claim 1, comprising:
generating a third transaction comprising a first input, the first input comprising a first input script, wherein the first input script is configured, so as when executed alongside the first output script, to unlock the first output script; and
causing the third transaction to be published on the blockchain.

3. The method of claim 2, comprising:
receiving a fourth transaction comprising a fourth input, the fourth input comprising a second input script; and
accepting the fourth transaction based on the one or more conditions being met, wherein the first condition of said one or more conditions is that the second input script corresponds to the first input script.

4. The method of claim 1 wherein accepting the second transaction comprises causing the second transaction to be published on the blockchain.

5. The method of claim 4, wherein said causing of the second transaction to be published on the blockchain comprises publishing the second transaction on the blockchain and/or propagating the second transaction to one or more blockchain nodes.

6. The method of claim 1 wherein said causing of the first transaction to be published on the blockchain comprises publishing the first transaction on the blockchain and/or propagating the first transaction to one or more different blockchain nodes.

7. The method of claim 1 wherein said receiving of the second transaction comprises receiving the second transaction from a party that generated the second transaction.

8. The method of claim 1, wherein said receiving of the second transaction comprises receiving the second transaction from a different blockchain node. or from a relaying node of the blockchain network.

9. The method of claim 2, wherein the first and third transactions are each identified by a respective transaction identifier, and wherein the method comprises:
receiving, from a party, a request for the respective identifiers of the first and third transactions; and
transmitting the respective identifiers of the first and third transactions to the party.

10. The method of claim 1, wherein in order for the second output script to correspond to the first output script, one, some or all of the following conditions must be met:
the second output script comprises a same number of operation codes as the first output script,
the second output script comprises a same order of operation codes as the first output script,
the second output script comprises a same number of data items as the first output script,
the second output script comprises a same order of data items as the first output script, and/or
the second output script comprises a same format of data items as the first output script.

11.-17. (canceled)

18. The method of claim 2, wherein the first and/or third transaction comprise a respective output comprising one, some or all of:
a master public key associated with the blockchain node;
a chain code linking the master public key with the first public key and/or a second public key;
a signature generated using the master public key;
a data length of a template output script;
a data length of a template input script;
a total number of opcodes contained in the template output script.

19. The method of claim 2, comprising:
generating a fifth transaction comprising a fifth output, the fifth output comprising a respective transaction identifier of the first and third transactions.

20. The method of claim 19, wherein the fifth output of the fifth transaction comprises one or more pairs of respective transaction identifiers, each pair comprising a respective transaction identifier of a different first transaction and a respective transaction identifier of a different third transaction, each different first and third transaction comprising, respectively, a different first output script and a different first input script.

21. A computer-implemented method of generating blockchain transactions, wherein the blockchain comprises a first transaction comprising a first output that comprises a first output script, and a third transaction comprising a first input that comprises a first input script, wherein the first input script is configured, so as when executed alongside the first output script, to unlock the first output script, and wherein the first and third transactions are generated by a blockchain node; the method being performed by a party and comprising:
obtaining the first transaction and/or the third transaction;
generating a second transaction comprising a) a second output comprising a second output script corresponding to the first output script of the first transaction, and/or b) a second input comprising a second input script corresponding to the first input script of the third transaction; and
causing the second transaction to be transmitted to the blockchain node.

22. (canceled)

23. The method of claim 21, wherein the first and third transactions are each identified by a respective transaction identifier, and wherein said obtaining comprises obtaining the respective transaction identifiers of the first and/or third transactions.

24. The method of claim 23, wherein said obtaining comprises transmitting a request to the blockchain node for the first and/or third transactions.

25. The method of claim 21, comprising:
transmitting a request for the first and/or third transactions to a different blockchain node, wherein the request comprises the respective transaction identifiers of the first and/or third transactions, and wherein said obtaining comprises obtaining the first and/or third transactions from the different node.

26. The method of claim 21, comprising:
transmitting, to the blockchain node, a request for a respective Merkle proof of the first and/or third transactions being published on the blockchain.

27. The method of claim 21, wherein the first and/or third transactions each comprise a master public key, and wherein the method comprises verifying that the master public key is associated with the blockchain node.

28. The method of claim 27, wherein the first transaction comprises a first public key and/or the third transaction comprises a second public key, and wherein the method comprises verifying that the first and/or second public keys are linked to the master public key.

29. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a method of accepting blockchain transactions, wherein the method is performed by a blockchain node of a blockchain network and comprises:
generating a first transaction comprising a first output, the first output comprising a first output script
causing the first transaction to be published on the blockchain;
receiving a second transaction comprising a second output, the second output comprising a second output script and accepting the second transaction based on one or more conditions being met, wherein a first condition of said one or more conditions is that the second output script corresponds to the first output script.

30. A computer program embodied on a non-transitory computer-readable storage and configured so as, when run on computer equipment, the computer equipment performs a method of any of accepting blockchain transactions, wherein the method is performed by a blockchain node of a blockchain network and comprises:
generating a first transaction comprising a first output, the first output comprising a first output script;
causing the first transaction to be published on the blockchain;
receiving a second transaction comprising a second output, the second output comprising a second output script and
accepting the second transaction based on one or more conditions being met, wherein a first condition of said one or more conditions is that the second output script corresponds to the first output script.
